(19) United States
(12) Patent Application Publication
(10) Pub. No.: US 2025/0390648 A1
(43) Pub. Date: Dec. 25, 2025

(54) CLOUD-NATIVE NETWORK-ON-CHIP VALIDATION INCLUDING SUB-TOPOLOGIES

(71) Applicant: Signature IP Corporation, Milpitas, CA (US)

(72) Inventors: Michael Loe Fernandez, Quezon City (PH); Kishore Mishra, Santa Clara, CA (US); Purna Mohanty, Sunnyvale, CA (US); Jertrude Fides Olaer Seguisa, Talon Tres (PH)

(73) Assignee: Signature IP Corporation, Milpitas, CA (US)

(21) Appl. No.: 19/245,520

(22) Filed: Jun. 23, 2025

Related U.S. Application Data
(60) Provisional application No. 63/663,205, filed on Jun. 24, 2024.
(60) Provisional application No. 63/688,925, filed on Aug. 30, 2024.

(51) Int. Cl. G06F 30/31; G06F 30/33; G06F 115/02

(52) U.S. Cl. CPC G06F 30/31; G06F 30/33; G06F 2115/02

(57) ABSTRACT

A collaborative Network-on-Chip (NoC) development environment (CNDE) is accessed. The CNDE is based on cloud-native software. The CNDE enables graphical design of a NoC topology within a database. A first NoC sub-topology within the NoC topology is created within the CNDE. The creating includes coupling a first network initiator, a first router, and a first network target. A second NoC sub-topology within the NoC topology is generated within the CNDE. The generating includes coupling a second network initiator, a second router, and a second network target. An interfacing block is inserted within the CNDE, enabling two-way communication between the first NoC sub-topology and the second NoC sub-topology. The NoC topology is validated. The validating ensures that the first network initiator is coupled to the first and second network targets, and that the second network initiator is coupled to the first and second network targets.

### RELATED APPLICATIONS

This application claims the benefit of U.S. provisional patent applications “Cloud-Native Network-On-Chip Validation With Sub-Topologies” Ser. No. 63/663,205, filed Jun. 24, 2024, and “Cloud-Native Network-On-Chip Validation Including Sub-Topologies” Ser. No. 63/688,925, filed Aug. 30, 2024.

Each of the foregoing applications is hereby incorporated by reference in its entirety.

### FIELD OF ART

This application relates generally to design automation and more particularly to cloud-native network-on-chip validation with sub-topologies.

### BACKGROUND

Computers are omnipresent, found in nearly every realm of human life. Early computers occupied one or more entire rooms, consumed significant power, contained many mechanical parts, and were costly to manufacture and repair. These early computers were limited to large businesses and used for processing data, calculating the trajectories of spacecraft, performing scientific calculations, and more. Over time, computers became physically smaller and found many additional uses. For example, personal computers began to appear in households. Portable computers became popular as well, though they were still large and heavy by modern standards. Today, most businesses depend on computers and most households own at least one personal computer. Today's computer systems can be standalone devices that can include a keyboard, video display, and so on. Laptops include all of these functions within a small package that can weigh as little as two or three pounds. Smartphones, smartwatches, streaming boxes, and more can be classified as computers, each having much more compute power than the early systems previously mentioned. The Internet can connect many computers together for data sharing, enabling a host of new applications and driving additional adoption and use. Systems can be created by combining multiple computers distributed across a number of remote locations by the Internet. Today, most individuals now rely on one or more computers for everyday online tasks such as tracking finances, word processing, surfing websites, online shopping, driving directions, and so on.

The chips that enable computer functionality have continued to decrease in size as well. Today, these chips are commonly designed as a single package with one or more microprocessors or microcontrollers and additional functional logic. Embedded systems can include memories of various types and speeds, input/output (I/O) electronics, Application-Specific Integrated Circuits (ASICS), controllers, and so on. Examples of embedded systems which can include these system elements are ubiquitous, finding use in automotive, aviation, marine, industrial, commercial, household, and personal applications. For example, wearable fitness devices can include components that can monitor a user's heart rate, number of steps walked during the day, and other health-related data. Alarm systems can include elements to alert a user when a person or animal is detected in a secure area. Smartphones can include keyboard and video screens allowing users to interact with various device functions.

As additional uses are found for these embedded systems, the chips that power them can grow more and more complex. Additional functions can be designed on the same silicon and merged with other functions. Today's integrated circuits can comprise billions of transistors representing multiple processors, controllers, I/O controllers, memory controllers, video processing engines, and so on. These embedded systems can deliver an impressive amount of compute power, including the ability to run one or more neural networks locally. As additional uses are found for computers and embedded systems, more and more functions will be added to these integrated circuits.

### SUMMARY

Microprocessor designs have evolved into large multicore semiconductor devices that comprise a complete system-on-chip (SoC). An SoC can integrate numerous subsystems into a single semiconductor platform, integrated circuit, package, etc. Subsystems can include memory, memory interfaces, input/output logic, clock generators, real-time clock functions, programmable logic, power management, analog interface circuitry, one or more processor cores, data compression cores, data security cores, and more. In many cases, third-party intellectual property (IP) subsystems (or cores) can be instantiated in an SoC design, which can operate with other logic that is designed in-house. This integration can require that the various IP cores communicate with other elements of the SoC. Various bus topologies can be used, including a point-to-point bus, a shared bus, a crossbar switched bus, and so on. But these communication paths can be problematic as they can result in long wire lengths. Signal propagation delay can require re-driving circuitry or adding a pipeline stage into the design which can reduce performance. Data synchronization and differing clock frequencies can also present interface issues. Bus sharing can cause contention and can result in bandwidth limitations. Bandwidth limitations can require arbitration schemes which can further reduce performance. Bus area and power dissipation can become appreciable. All of these problems can multiply as chip sizes increase, additional functions are added, and operating frequencies are increased. A recent trend in subsystem communication has been to replace direct bus wiring between subsystems with network-on-chip (NoC) technology. A NoC can include router-based, packet-switching networks and network topologies which can alleviate the performance limitations of point-to-point interconnect buses.

Techniques for cloud-native network-on-chip validation with sub-topologies are disclosed. A collaborative Network-on-Chip (NoC) development environment (CNDE) is accessed. The CNDE is based on cloud-native software. The CNDE enables graphical design of a NoC topology within a database. A first NoC sub-topology within the NoC topology is created within the CNDE. The creating includes coupling a first network initiator, a first router, and a first network target. A second NoC sub-topology within the NoC topology is generated within the CNDE. The generating includes coupling a second network initiator, a second router, and a second network target. An interfacing block is inserted within the CNDE, enabling two-way communication between the first NoC sub-topology and the second NoC sub-topology. The NoC topology is validated. The validating ensures that the first network initiator is coupled to the first and second network targets and that the second network initiator is coupled to the first and second network targets.

A processor-implemented method for design automation is disclosed comprising: accessing a collaborative Network-on-Chip (NoC) development environment (CNDE), wherein the CNDE is based on a cloud-native software, and wherein the CNDE enables graphical design of a NoC topology within a database; creating, within the CNDE, a first NoC sub-topology, wherein the first NoC sub-topology is within the NoC topology, and wherein the creating includes coupling a first network initiator, a first router, and first network target; generating, within the CNDE, a second NoC sub-topology, wherein the second NoC sub-topology is within the NoC topology, and wherein the generating includes coupling a second network initiator, a second router, and second network target; inserting, within the CNDE, an interfacing block, wherein the interfacing block enables two-way communication between the first NoC sub-topology and the second NoC sub-topology; and validating the NoC topology, wherein the validating ensures that the first network initiator is coupled to the first network target and the second network target, and that the second network initiator is coupled to the first network target and the second network target. In embodiments, the first NoC sub-topology and the second NoC sub-topology are based on different clock frequencies. In embodiments, the interfacing block includes a digital phased lock loop (DPLL). Some embodiments comprise sending, by the first NoC sub-topology, to the interfacing block, data and a first clock, wherein the first NoC sub-topology is based on the first clock, and wherein the first clock provides an input to the DPLL. Some embodiments comprise generating, by the DPLL, a second clock. Some embodiments comprise forwarding, to the second NoC sub-topology, by the interfacing block, the second clock, wherein the second NoC sub-topology is based on the second clock that was forwarded, and wherein the forwarding includes the data.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cloud-native network-on-chip validation with sub-topologies.

FIG. 2 is a flow diagram for validating a topology.

FIG. 3 is an example of a NoC with sub-topologies.

FIG. 4 is an example of a NoC with sub-topologies and interfacing blocks.

FIG. 5 is a detail of an interfacing block.

FIG. 6 is an example of a CNDE graphical interface.

FIG. 7 is an example of NoC sub-topologies within a CNDE.

FIG. 8 is an example of editing a network initiator within a CNDE.

FIG. 9 is an example of tracing a connectivity error.

FIG. 10 is a system diagram for cloud-native network-on-chip validation with sub-topologies.

### DETAILED DESCRIPTION

A system-on-chip (SoC) can integrate many logical subsystems on a single chip such as memory controllers, cache hierarchies, I/O device controllers, processors, multi-core processors, and so on. As a result, transistor counts for today's SoCs can be in the billions. These large SoC designs can cause buses and signals to travel long distances between subsystems, presenting significant timing challenges. Often, the addition of one or more pipeline stages is necessary to meet frequency requirements, reducing overall performance. In addition, buses between subsystems can require more than one wiring channel per bit to reduce RC delay. These buses can make floorplanning a difficult task at the chip level.

To address these challenges, today's SoC designs can implement a Network-on-Chip (NoC) interface. A NoC typically includes network interfaces that allow logic to connect to a chip-wide network. The network can be packetized, with routers that guide information, stored in data packets, to specific logic blocks within subsystems of the SoC. Though NoC technology can solve many of the issues resulting from point-to-point bus topologies, they can be prone to error and can require long design times. Further, an overall NoC design can be divided into multiple NoC sub-topologies within the SoC to ease floorplanning. Each sub-topology within the NoC topology must be checked for data continuity, matching protocols, clocking speeds, data width, and so on. Checking the entire NoC design is critical to ensure that each subsystem can communicate with other needed subsystems within the final SoC. Generating an accurate netlist, which can be an HDL description of the entire network, including one or more sub-topologies, can also be a consuming and error-prone task. For these and other reasons, the NoC design process often needs human input and intervention. Disclosures address the need for automated design, testing, netlisting, and validation of NoC sub-topologies within an SoC.

A processor-implemented method for design automation is disclosed. A collaborative Network-on-Chip (NoC) development environment (CNDE) is accessed. The CNDE can be a design automation tool to aid system-on-chip (SoC) design. The CNDE is based on a cloud-native software. The CNDE enables graphical design of a NoC topology within a database. The CNDE can show a graphical representation of the NoC topology. A first NoC sub-topology is created within the CNDE. The first NoC sub-topology is within the NoC topology. The creating includes coupling a first network initiator, a first router, and a first network target. A second NoC sub-topology is generated within the CNDE. The second NoC sub-topology is within the NoC topology. The first NoC sub-topology and the second NoC sub-topology can be based on different clock frequencies. The generating includes coupling a second network initiator, a second router, and a second network target. An interfacing block is inserted within the CNE. The interfacing block enables two-way communication between the first NoC sub-topology and the second NoC sub-topology. The interfacing block can comprise a clock domain crossing block. The NoC topology is validated. The validating ensures that the first network initiator is coupled to the first network target and the second network target, and that the second network initiator is coupled to the first network target and the second network target. The CNDE can extract a NoC netlist. The CNDE can share the database between two or more users.

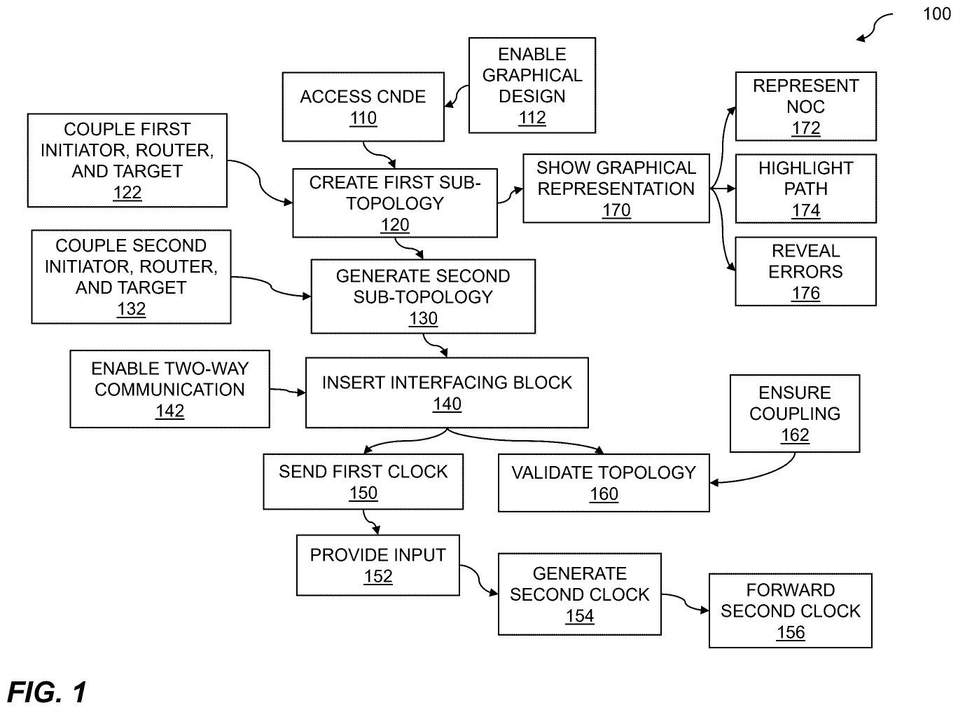

FIG. 1 is a flow diagram for cloud-native network-on-chip validation with sub-topologies. NoC design within an SoC can be enabled by a cloud-native design environment which can be a Collaborative Network-on-Chip development environment (CNDE). The CNDE can generate a validated NoC along with a correct netlist to ensure that network communications are properly implemented in the target semiconductor processor design, which can be an SoC. The CNDE enables graphical design of a NoC topology within a database. A first NoC sub-topology is created by the CNDE within the NoC topology. The creating includes coupling a first network initiator, router, and network target. A second NoC sub-topology is generated by the CNDE within the NoC topology. The generating includes coupling a second network initiator, router, and network target. An interfacing block is inserted to enable two-way communication between the first and second NoC sub-topologies. The NoC topology is validated to ensure that the first network initiator is coupled to the first network target and the second network target, and that the second network initiator is coupled to the first network target and the second network target.

The flow 100 includes accessing a collaborative Network-on-Chip (NoC) development environment (CNDE) 110. A collaborative development environment can enable two or more users to participate in the development of an SoC design. Collaboration can mean that the users are located in the same location or in remote locations connected by a network or other communications interface that enables data sharing. In embodiments, the CNDE is based on cloud-native software. Cloud-native software can reside at a physically remote location, accessible as needed, using IT resources for delivery to one or more users. Cloud-native software can allow the users to access technology services such as computing power and storage without requiring individual licenses and copies of software in their own locations. Cloud-native software can be based on a software-as-a-service (SaaS) model. The interface to cloud-native software can be a web browser, application, mobile app, and so on. In embodiments, the CNDE enables graphical design 112 of a NoC topology within a database. The database can be collaborative. Thus, more than one user is able to view, edit, validate, etc. the NoC topology as it is designed, checked, validated, etc. The CNDE can provide functionality for displaying the components of the NoC design, exploring a file system within the design environment, setting user sharing privileges, displaying performance matrices, validating a topology and sub-topologies, generating a netlist of the NoC topology, simulating the topology and/or sub-topologies, displaying the results, and so on.

The flow 100 includes creating, within the CNDE, a first NoC sub-topology 120. An SoC chip design can include a NoC topology to address aforementioned design challenges. The NoC topology can include a network that couples one or more subsystems within the SoC. The network can be based on a TCP/IP packetized protocol or another protocol. Each of the one or more subsystems can include a NoC sub-topology which can be part of the overall NoC design and which can couple the subsystem to the network. A first NoC sub-topology can be created within the CNDE. In embodiments, the first NoC sub-topology is within the NoC topology. The first NoC sub-topology can be associated with any subsystem of the SoC, such as a processor core, a peripheral component interconnect express (PCI-E) controller, security logic, and so on. The first NoC sub-topology can be coupled to other network sub-topologies via one or more routers, which can be part of the network. The first NoC sub-topology can include a packetized interface, can communicate over a coherent or a non-coherent protocol, can support transmissions over control protocol/internet protocol (TCP/IP), and so on.

In embodiments, the creating includes coupling a first network initiator, a first router, and first network target 122. A network initiator can be a block of logic within a subsystem of the SoC, such as a processor core, that generates a data transaction. A network target can be a block of logic within a subsystem of the SoC, such as a memory device, that responds to a data transaction from a network initiator. A data transaction can be in packetized form that can contain a header along with data. The header can contain a target address and other controls. A router can direct packetized data transmissions from a network initiator to a network target. For example, a processor can start a communication over the NoC topology to a memory controller. Though designated a network target in this example, the memory controller can also send, via the NoC topology, information back to the processor. The communication between initiator and target can be bidirectional. Network initiators and network targets can be included within the same sub-topology or a different sub-topology within the NoC topology.

The flow 100 includes generating, within the CNDE, a second NoC sub-topology 130. As mentioned above, a NoC topology can contain more than one NoC sub-topology. The NoC sub-topologies can be coupled. Logic within or that is close to a sub-topology can be coupled to other portions of the SoC via the sub-topology. In this way, logic elements can communicate with either logic elements within the same sub-topology or another sub-topology on the SoC without the need for point-to-point buses. In embodiments, the second NoC sub-topology is within the NoC topology. Similar to the first NoC sub-topology, the second NoC sub-topology can be associated with a subsystem of the SoC, such as a processor, PCI-E controller, security logic, and so on. The second NoC sub-topology can include one or more routers, can include a packetized interface, and can communicate over a coherent or a non-coherent protocol. The second NoC sub-topology can support transmissions over control protocol/internet protocol (TCP/IP), or another protocol.

In embodiments, the generating includes coupling a second network initiator, a second router, and second network target 132. Similar to the first network initiator, the second network initiator can initiate a transaction, from the second sub-topology, to a second network target anywhere within the NoC. A second network target can receive the communication within the second sub-topology. The first sub-topology and the second sub-topology can be coupled via the NoC topology without the need for point-to-point buses. The NoC topology can include a packetized interface to carry data and control signals between sub-topologies. Because both sub-topologies are part of the overall NoC topology, the first network initiator can communicate with the second network target. Likewise, the second network initiator can communicate with the first network target.

The flow 100 includes inserting, within the CNDE, an interfacing block 140. An interfacing block can comprise a pipeline stage to reduce long RC delays in the path between NoC sub-topologies. One or more interfacing blocks can be inserted. The interfacing blocks can be inserted inside or outside of any NoC sub-topology. The interfacing blocks can include data buffers. Additionally, the interfacing block can be used when a sub-topology sends data to a receiving sub-topology with a different width data bus. The inserting can include one or more interfacing blocks. In embodiments, the inserting enables two-way communication 142 between the first NoC sub-topology and the second NoC sub-topology. In embodiments, the creating, the generating, and the inserting occur graphically within the CNDE. In other embodiments, the creating, the generating, and the inserting are based on importing data from a file. The file can be in any format, such as a hardware description language (HDL), a netlist, a text file, etc. The file can be uploaded to be included in the database within the cloud-native software environment. Alternatively, the file can exist in the cloud-native software environment and can be updated by one or more users.

In embodiments, the first NoC sub-topology and the second NoC sub-topology are based on different clock frequencies. SoC subsystems can operate at different clock speeds depending on performance requirements, logic complexity, area, and so on. This can also cause the NoC sub-topologies to run at different speeds across the SoC. Third party IP can be included in the SoC design which can also introduce clocking complexities. In embodiments, the interfacing block comprises a clock domain crossing block. The interfacing block can transition data between clocks of various frequencies. A number of methods can be used when interfacing between sub-topologies with different clocks. For example, the interfacing block can include an asynchronous FIFO, a synchronous FIFO, a two-flip-flop synchronizer, a toggle synchronizer, a pulse synchronizer, a gray encoder, a mux synchronizer, handshaking between clock domains, and so on. The interfacing block can also accomplish a domain crossing by generating and distributing a new clock. In embodiments, the interfacing block includes a digital phased lock loop (DPLL). Other embodiments include sending, by the first NoC sub-topology, to the interfacing block, data and a first clock 150. In embodiments, the first NoC sub-topology is based on the first clock. In further embodiments, the first clock provides an input 152 to the DPLL. Within the interfacing block, the first clock can be used to capture the data that was sent by the first sub-topology. Embodiments include generating, by the DPLL, a second clock 154. The first clock can also serve as a reference clock to the DPLL so that the DPLL can generate the second clock. The second clock can be a multiple of the first clock or some other clock value. The data can be synchronized with the second clock by the interfacing block. Further embodiments include forwarding, to the second NoC sub-topology, by the interfacing block, the second clock 156. In other embodiments, the second NoC sub-topology is based on the second clock that was forwarded. The second clock can be distributed within the second sub-topology to form the functional clock. In other embodiments, the forwarding includes the data.

The flow 100 includes validating the NoC topology 160. As stated previously, network initiators and targets can communicate directly between NoC sub-topologies or by using one or more interfacing blocks between NoC sub-topologies. The NoC topology, which can include one or more sub-topologies and one or more interfacing blocks, can be validated. The validating can include checking that every required communication path is coupled correctly. In embodiments, the validating ensures that the first network initiator is coupled to the first network target and the second network target, and that the second network initiator is coupled to the first network target and the second network target 162. That is, the validating can ensure that the first network initiator and the second network initiator can properly communicate with either network target, regardless of which sub-topology includes the initiators and targets. The validating can include criteria such as performance, timing, clocks, bus width, protocols, and so on. In embodiments, the validating occurs in response to a change, in the CNDE, by a user. As described previously, the CNDE can be a collaborative, graphical design environment for designing a NoC topology. The validating component within the CNDE can enable design and debug of one or more NoC sub-topologies, the overall NoC topology, and so on. Validation steps can run automatically or manually after a user changes an aspect of the NoC topology, uploads a new data file, updates a characteristic of a sub-topology element, and so on.

The flow 100 includes showing, by the CNDE, a graphical representation 170 of the NoC topology. A graphical representation of the NoC topology can provide visual clarification of the topology that was designed by one or more collaborative users. The graphical representation can be displayed on a web browser or software running on a compute device, a mobile device, a tablet, and so on. The graphical representation can include one or more sub-topologies, one or more interfacing blocks, one or more routers, technical details of any component of the NoC or NoC sub-topology, wiring between NoC elements or NoC sub-topologies, and so on. Embodiments include representing, by the CNDE, each NoC sub-topology within the NoC topology by a different color 172. Different colors can help clarify a complex visual illustration of NoC sub-topologies. For example, a first sub-topology can be depicted in green, and a second sub-topology can be depicted in blue. Any NoC sub-topology can be represented by any color.

Other embodiments include highlighting a communications path 174 to a network target when the network target is selected, by a user, within the CNDE. Visually highlighting a communications path can help the designer to understand the overall topology of the NoC, as well as to see which interconnection paths are present and/or missing. The communications path can include one or more network initiators, routers, interfacing blocks, and targets from the first sub-topology, the second sub-topology, or any other sub-topology included in the NoC design. In further embodiments, the validating includes revealing, by the CNDE, one or more connectivity errors 176 when one or more initiators are unable to communicate with one or more network targets. A connectivity error can occur when a particular network initiator is intended to connect to a particular network target, but is unable to communicate with it. This can occur for a number of reasons, such as network congestion, errors in NoC topology, errors in one or more NoC sub-topologies, a mismatch in clock frequency, data width, and so on. In a usage example, a first sub-topology can implement a 128-bit data width while a second sub-topology can implement a 64-bit data width. Thus, a user must ensure that data is not lost when sending data from the first sub-topology to the second sub-topology. The CNDE can detect the data width mismatch and highlight to the user that data may be lost unless the data width mismatch is corrected in the overall NoC design. This can be accomplished by inserting buffers, an interfacing block, handshaking, and so on within the CNDE.

Various steps in the flow 100 may be changed in order, repeated, omitted, or the like without departing from the disclosed concepts. Various embodiments of the flow 100, or portions thereof, can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

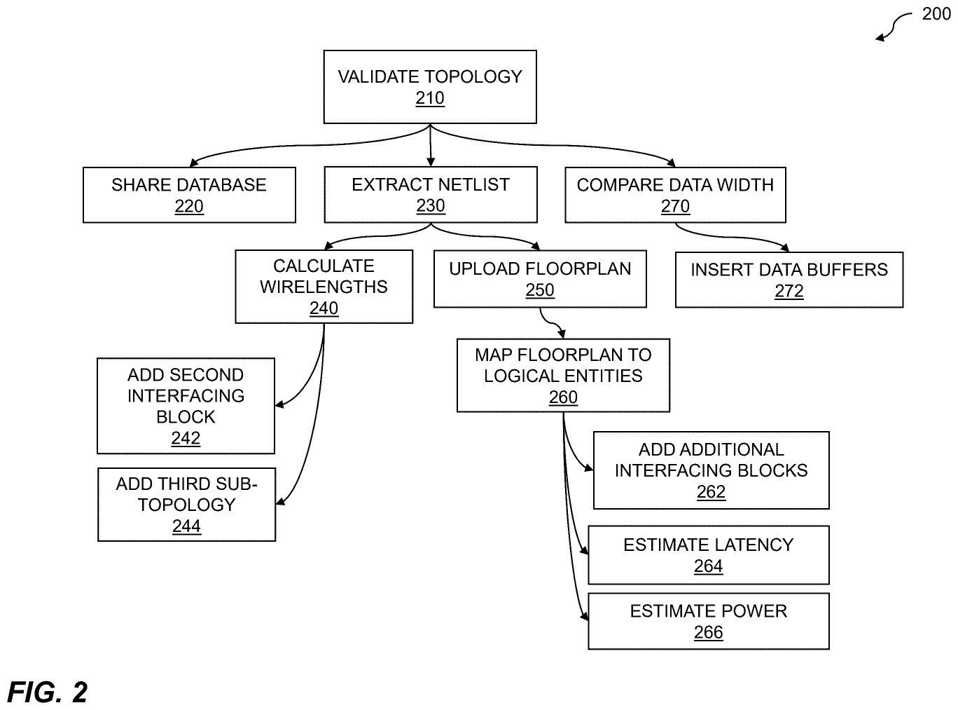

FIG. 2 is a flow diagram for validating a topology. A NoC design within an SoC can be enabled by a cloud-native design environment such as the CNDE. The CNDE can enable graphical design of a NoC topology within a database. The NoC design can include one or more NoC sub-topologies. Each NoC sub-topology can include one or more network initiators, routers, interfacing blocks, and/or network targets. As the overall NoC design takes shape, the user can validate the NoC topology within the CNDE. Validating the NoC topology ensures that it functions properly when included in the overall SoC design.

The flow 200 includes validating the NoC topology 210. As described above, the validating can include checking that every required communication path is coupled correctly and that the path will pass checks such as performance, timing, clock, protocol, etc. In embodiments, the validating ensures that the first network initiator is coupled to the first network target and the second network target, and that the second network initiator is coupled to the first network target and the second network target. That is, the validating can ensure that the first network initiator and the second network initiator can properly communicate with either network target, regardless of which sub-topology includes the initiators and targets.

The flow 200 includes sharing, by the CNDE, the database 220, between two or more users. Collaborative design can involve two or more users that share a common design task or tasks. Collaborative design can share a common database that is created, stored, updated, retrieved, etc. as needed by the design collaborators and others. Users can be physically located in the same location or can be located remotely and participate at differing times. In further embodiments, the creating, the generating, and the inserting are based on importing data from a file. The file can be in any format, such as a hardware description language (HDL), netlist, text file, and so on. The file can be stored locally and can be uploaded to be included in the database within the cloud-native software environment. Alternatively, the file can exist in the cloud-native software environment and can be updated by one or more users.

The flow 200 includes extracting, by the CNDE, a NoC netlist 230. The netlist can contain a list of network connections, or nets, that result from the visually represented NoC design. The netlist can be included in a file that can be downloaded to a user from the CNDE. In embodiments, the NoC netlist can include one or more stubs. In further embodiments, the one or more stubs can comprise an integration point for a description of the first network initiator, the second network initiator, the first network target, and the second network target. In embodiments, the description can be based on a hardware description language (HDL). The HDL can include VHDL, Verilog, DSL, and so on. In this way, the entire NoC design can be quickly extracted into the HDL to be used for simulation, calculations, and so on.

The flow 200 includes calculating, by the CNDE, one or more wirelengths 240. The one or more wirelengths can be based on a floorplan associated with the netlist, information within the netlist, etc. The calculating can be based on an estimate. A determination can be made, based on the one or more wirelengths, if design timing constraint can be achieved. If not, redrive buffers or interfacing blocks can be added between NoC sub-topologies. Thus, in embodiments, the calculating includes adding a second interfacing block 242. In embodiments, the adding can be accomplished when the one or more wirelengths are above a first threshold. The first threshold can be associated with a timing goal. In other embodiments, the second interfacing block comprises a pipeline stage. Even with two interfacing blocks between a first and second sub-topology, it is possible that a path may still not meet timing criteria. Additional interfacing blocks can be added to ensure that timing goals are met. Additional sub-topologies can also be added. In embodiments, the calculating includes adding a third sub-topology 244. In embodiments, the adding can be accomplished when the one or more wirelengths are above a second threshold. The second threshold can be associated with a timing goal. The second threshold can be the same as the first threshold. In embodiments, the third sub-topology is within the NoC topology. In further embodiments, the one or more wirelengths are based on a Manhattan wiring algorithm. The CNDE can compute wirelength based on a Manhattan wiring algorithm where the physical wire paths follow a regular grid structure. The wirelengths can be based on a heuristic algorithm or another algorithm. The wirelengths can be estimated by the CNDE.

The flow 200 includes uploading, to the CNDE, floorplan information 250. The floorplan information can include location data, size data, aspect ratio data, transistor count data, and so on. Once a chip floorplan is established, data can be set to the CNDE for analysis. The floorplan information can be sent to the CNDE by a user and shared by other users working on the same design. The uploading can include physical data associated with the NoC topology design. Thus, the floorplan information can expose additional insights regarding the timing of signals within the NoC topology. Embodiments include mapping, by the CNDE, the floorplan information to one or more logical entities within the NoC topology 260. The CNDE can map the uploaded floorplan to logical entities, such as network initiators, routers, and targets, within the NoC topology design. Thus, each entity within the CNDE can be updated with specific floorplanning data from the SoC design. The uploading and mapping of floorplan data can lead to more accurate wirelength calculations. However, as noted above, the CNDE can generate wirelength estimates without detailed floorplan information. As a NoC design progresses, it can become evident that one or more signals will not meet timing. Further embodiments include adding one or more additional interfacing blocks 262. The one or more additional interfacing blocks can help to meet timing requirements. In further embodiments, the floorplan information includes a wirelength above a third threshold. The third threshold can be associated with a timing requirement. The third threshold can be the same as the first or the second threshold. In embodiments, the one or more additional interfacing blocks comprise one or more pipeline stages.

Additional information can be extracted by the CNDE once floorplanning information has been uploaded. The flow 200 includes estimating latency information 264 of the NoC topology. After the netlist contains imported floorplan information, an estimate of path latency, including RC delay, can be completed for one or more paths within the NoC topology. The latency information can be based on the netlist and/or floorplan information that was uploaded. The flow 200 includes estimating power consumption 266 of the NoC topology. Because the floorplan includes physical information about the NoC topology and NoC sub-topologies, an estimate of power consumption can be completed for the entire NoC topology. The power consumption estimate can be based on the netlist.

The flow 200 includes comparing a first data width 270. In embodiments, the validating can include the comparing. In embodiments, the first data width is associated with the first NoC sub-topology. In further embodiments, the second data width is associated with the second NoC sub-topology. A first NoC sub-topology within a NoC topology can have a different data width than a second NoC sub-topology within the NoC topology. In this case, care must be taken to avoid data loss. The validating can include checking and notifying a user, by the CNDE, when there is a difference between coupled NoC sub-topologies without proper handling. For example, the first NoC sub-topology can include a clock and a 128-bit data width, while the second NoC sub-topology can be based on the same clock and can include a 64-bit data width. In embodiments, the first data width is different than the second data width. A situation such as this can be addressed by inserting an interfacing block between the sub-topologies. Other embodiments include inserting data buffers 272 within the interfacing block. Data buffers can be included in the interface block to ensure that when the first NoC sub-topology sends data to the second NoC sub-topology, buffers can be used to save data, preventing data loss. The second NoC sub-topology can read data from the buffers in 64-bit increments. Communications between the first NoC sub-topology and the interfacing block can be based on a credit system. If the buffers are full, the interfacing block can remove credit from the first NoC sub-topology. In response, the first NoC sub-topology can wait to send the next 128-bit data word until credit is restored (when buffer space is again available).

Various steps in the flow 200 may be changed in order, repeated, omitted, or the like without departing from the disclosed concepts. Various embodiments of the flow 200, or portions thereof, can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

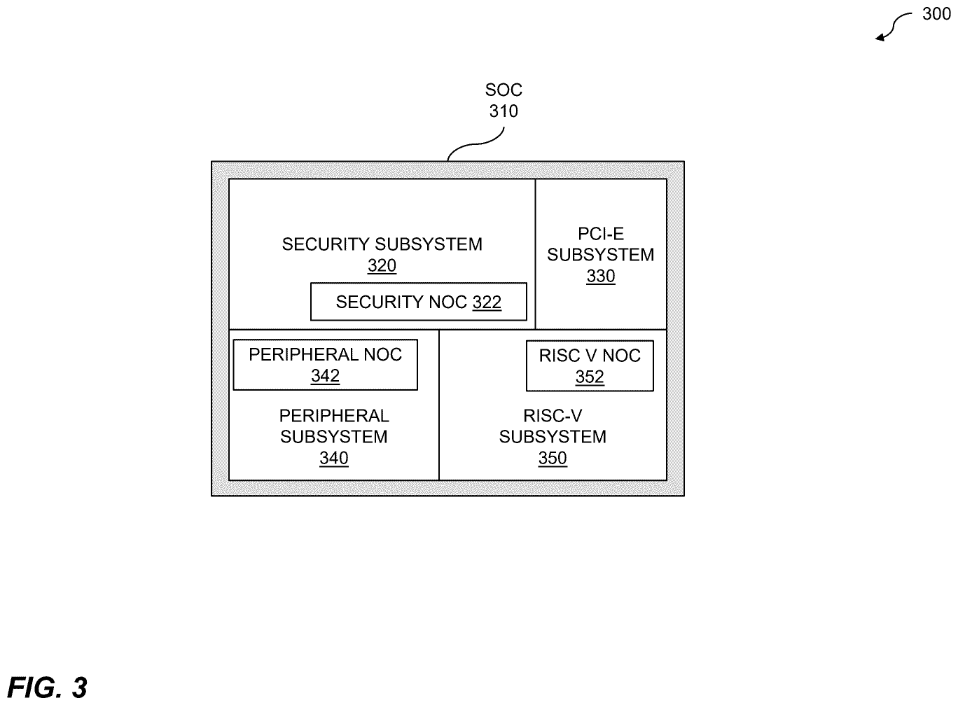

FIG. 3 is an example of a NoC with sub-topologies. The example 300 includes an SoC design 310. The SoC can include numerous subsystems in a single semiconductor platform, chip, package, etc. These subsystems can include one or more processors, memories, input/output devices, external interfaces, graphics processor units (GPUs), modems, and the like. The subsystems can include combinational logic, circuit arrays, etc. Third-party intellectual property (IP) subsystems or cores can be instantiated in an SoC design, which can operate with other logic that is designed in-house. This integration can require that the various IP cores can communicate with other elements of the SoC via the NoC topology. In the example 300, the subsystems include a security subsystem 320. The security subsystem can include logic and circuits that provide security functions to an application running on the SoC. The security system can help to prevent cybersecurity attacks on the SoC. The security functions can include encryption/decryption, authenticity verification, verification of security sensors, storage of cryptographic tools, and the like. The SoC can include a PCI-Express (PCIe) subsystem 330. The PCI-Express subsystem can include logic and circuits that provide PCIe communications to and from input/output (I/O) devices. The SoC can include a peripheral subsystem 340. The peripheral subsystem can include logic and circuits that provide an interface to off-chip peripheral devices including input, output, and storage devices, and so on. The SoC can include a RISC-V subsystem 350. The RISC-V subsystem can include logic and circuits that provide one or more processing cores, local caches, memory systems, etc. within the SoC. While subsystem 350 is shown as a RISC-V subsystem, in practice it can be based on any architecture such as ARM, X86, and so on. The subsystem blocks can be floorplanned within the SoC as shown in in the example 300. A plurality of configurations is possible due to wire and performance optimizations.

As described above and throughout, a network-on-a chip (NoC) topology can be created for the SoC. The NoC topology can enable packetized communications within the SoC. The NoC topology can include one or more sub-topologies. The sub-topologies can be based on a physical location of one or more subsystems within the SoC. The sub-topologies can be placed anywhere within the SoC. The example 300 shows three NoC sub-topologies including a security NoC sub-system 322, a peripheral NoC sub-system 342, and a RISC-V NoC sub-system 352. An SoC subsystem can be small enough so that it does not require its own NoC sub-topology, as in the case with the PCIe subsystem. In the example 300, the PCIe subsystem can be coupled to another sub-topology, for example the RISC-V NoC sub-topology, to provide packetized communications to other subsystems.

As shown in example 300, any NoC sub-topology can be integrated into the floorplan of a logic subsystem. The sub-topologies can include one or more nodes. A sub-topology node can comprise a network interface, a router, ingress ports, egress ports, physical links such as wiring, and so on. The network interface can packetize and/or depacketize data. The routers can direct packetized network traffic to other sub-topologies within and/or outside of an SoC subsystem. The ingress and egress ports can couple a logic block within a sub-topology to another logic block in the sub-topology, another node in the sub-topology, a node in a different sub-topology, and so on. Packetized network traffic sent between nodes can include data, a logic block ID, coherency data, priority information, or other data. Dividing the NoC sub-topology into sub-topologies enables additional flexibility to meet performance goals. For example, when located in close physical proximity, the logic blocks can be concurrently synthesized, simulated, timed, etc. with the NoC sub-topology which services them. Nodes with a sub-topology can be coupled with a structure such as a ring, an n-dimensional mesh, a torus, a k-ary tree, a cube mesh, or any other structure.

The network interface within each node of the sub-topologies can translate between different communications protocols. For example, the security NoC sub-topology can be based on a first communications protocol. However, the logic within the SoC security subsystem can be based on a second communications protocol. The network interface within a node within the security NoC sub-topology can translate from the second communications protocol to the first communications protocol. The other NoC sub-topologies can also be based on the first communications protocol, enabling packetized communications between NoC sub-topologies. The first and second communications protocols can be coherent or non-coherent. The first communications protocol can provide a unidirectional data transfer between nodes of the sub-topology or between sub-topologies. The first communications protocol can provide a bidirectional data transfer between nodes of the sub-topology or between sub-topologies.

The location of each of the sub-topologies included on the SoC 310 can be adjusted. The node locations within the sub-topology structure can be customized to accommodate the timing, floorplanning, etc. requirements of the subsystem. For example, nodes within the sub-topology may be placed closer to circuit elements within the subsystem that have more critical timing than other elements of the subsystem. The overall size, shape, and/or location of the sub-topology can be optimized to accommodate factors of size, chip location, buffer sizes, quality of service (QOS) policies, arbitration, latency, bandwidth requirements of the subsystem, and so on. The location of the sub-topologies within a subsystem can be optimized with respect to other sub-topologies to limit long wire delays. The optimizing can be based on a place-and-route algorithm. The results of the place-and-route algorithm can be modified by a human designer to further optimize for one of the factors listed above. The optimization can be performed by a human designer. The optimization can include synthesizing or re-synthesizing the sub-topology by the CNDE with different parameters such as timing constraints, logic minimization, and so on. The optimization can be based on bandwidth or latency requirements.

The sub-topologies can be placed within the SoC, based on the optimization. The placing can comprise physically instantiating a sub-topology within a logic block. Routing can then be finalized within the logic block and the sub-topology at the same time, allowing for optimization of latency and bandwidth. As described above, the sub-topologies can be coupled, wherein the coupling includes a communications protocol. The communications protocol can include packets. Information can be sent in the form of packets from a sending node to a receiving node within the sub-topology. The packets can be sent from a sending node in one sub-topology to a receiving node in another sub-topology using the communications protocol. For example, in FIG. 3, a node within the RISC-V sub-topology can send information via packets to the security sub-topology through the communications protocol. The packets can comprise a number of flits, or flow control units. The flit can comprise header information which can define the routing path to the receiving node. The receiving node in the security sub-topology can decode the header to determine the final routing destination. A routing calculation can be performed by a router within the receiving node of the security sub-topology. The routing calculation can be based on the header.

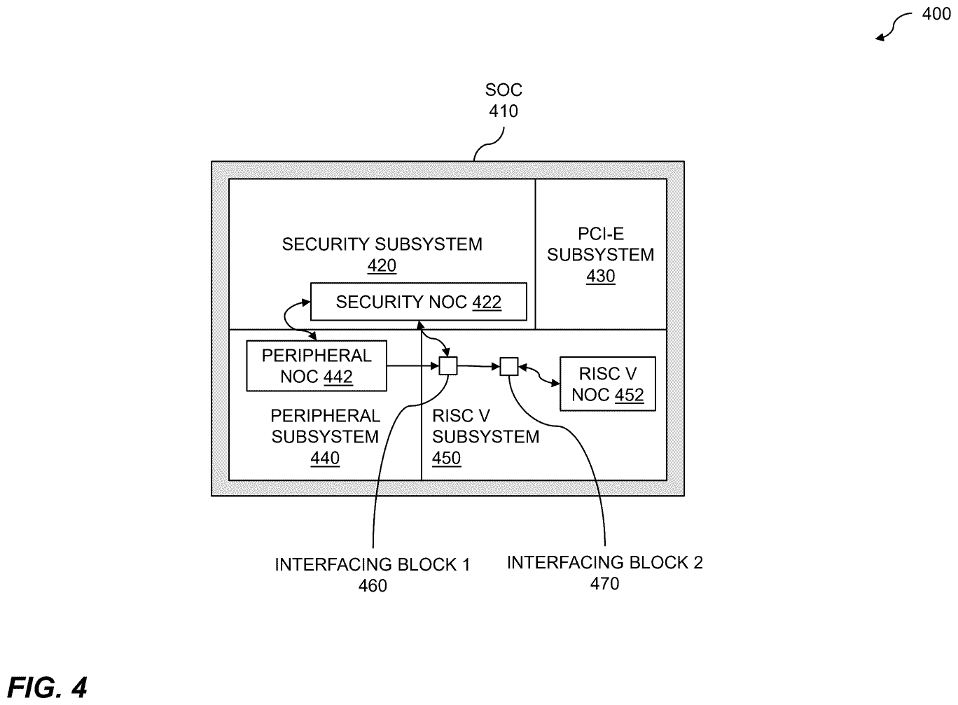

FIG. 4 is an example of a NoC with sub-topologies and interfacing blocks.

The example 400 includes an SoC design 410. As explained above and throughout, the SoC can include numerous subsystems in a single semiconductor platform, chip, package, etc. These subsystems can include one or more processors, memories, input/output devices, external interfaces, graphics processor units (GPUs), modems, and the like. The subsystems can include combinational logic, circuit arrays, etc. Third-party IP subsystems or cores can be instantiated in an SoC design, which can operate with other logic that is designed in-house. This integration can require that the various IP cores communicate with other elements of the SoC. The SoC can include one or more subsystems. A NoC topology can be created for the SOC. The NoC topology can include one or more sub-topologies. The one or more sub-topologies can be based on a physical location of the one or more logic blocks. The sub-topologies can include one or more nodes which can comprise a network interface, a router, ingress ports, egress ports, physical links such as wiring, and so on. The network interface can packetize and/or depacketize data. The routers can direct packetized network traffic to other sub-topologies within and/or outside of an SoC subsystem. The ingress and egress ports can couple a logic block within a sub-topology to another logic block in the sub-topology, another node in the sub-topology, a node in a different sub-topology, and so on. Packetized network traffic sent between nodes can include data, a logic block ID, coherency data, priority information, or other data. The nodes within and/or between the sub-topologies can include a structure such as a ring, an n-dimensional mesh, a torus, a k-ary tree, a cube mesh, or any other structure. Nodes within a sub-topology can be located to minimize timing delays in circuits that have timing challenges. Additional nodes can be added within the sub-topology, as space permits, to help solve timing issues as well. The location of the sub-topologies within a logic block can be optimized with respect to other sub-topologies to limit long wire delays. The sub-topologies can be placed within the SoC, based on the optimization.

In the example 400, four SoC subsystems are shown within the SoC floor plan. A security subsystem 420 is shown. The security subsystem can include logic and circuits that provide security functions to an application running on the SoC, such as helping to prevent cybersecurity attacks. The security functions can include encryption/decryption, authenticity verification, verification of security sensors, storage of cryptographic tools, and the like. In the example 400, the security subsystem includes a security NoC sub-topology 422. The example 400 includes a PCI-Express (PCIe) subsystem 430. The PCIe subsystem can include logic and circuits that provide PCIe communications to input/output (I/O) devices. The example 400 includes a peripheral subsystem 440. The peripheral subsystem can include logic and circuits that provide an interface to off-chip peripheral devices including input, output, storage devices, and so on. In example 400, the peripheral subsystem includes a peripheral NoC sub-topology 442. The example 400 includes a RISC-V subsystem 450. The RISC-V subsystem can include logic and circuits that provide one or more processing cores, local caches, memory systems, etc. within the SoC. In the example 400, the RISC-V subsystem includes a RISC-V NoC sub-topology 452. All of the subsystems can be synthesized, custom designed, verified, timed, and/or floorplanned as shown in the example 400.

Note that not all subsystems require their own NoC sub-topology. For example, in the example 400, the PCIe subsystem is shown without a NoC sub-topology. A subsystem can be small enough that it does not require its own NoC sub-topology, as in the case with the PCIe subsystem. In embodiments, the PCIe sub-system can be coupled to one or more NoC nodes within another sub-topology, for example the RISC-V NoC sub-topology, to provide packetized communications to other subsystems. The sub-topologies on the SoC can be coupled, which can be based on a communications protocol. The communications protocol can include packets. Information can be sent in the form of packets from a sending node to a receiving node within the same or a different NoC sub-topology. In the example 400, the security sub-topology and the peripheral sub-topology are configured to send data directly to each other via their respective NoC sub-topologies. However, as shown in the example 400, both the security sub-topology and the peripheral sub-topology are unable to communicate directly with the RISC-V sub-topology. The inability to communicate directly can be due to a data bus width difference, clock difference, wire distance, protocol difference, synchronization issue, and so on. Communications between these blocks can be enabled by interfacing blocks. In the example 400, two interfacing blocks have been included in the SoC floor plan, interfacing block 1 460 and interfacing block 2 470. These interfacing blocks can enable communications between the security, peripheral, and RISC-V subsystems. Recall that the PCIe subsystem in this floor plan can rely on the RISC-V NoC sub-topology. Thus, the interfacing blocks enable communications among subsystems within the SoC. A single interfacing block can couple a sending sub-topology to a receiving sub-topology. Multiple interfacing blocks can be placed in series between a sending sub-topology and a receiving sub-topology. Inserting more than one interfacing block can be necessary when the two sub-topologies are a long distance apart in the floor plan. One or more interfacing blocks can comprise one or more pipeline stages to reduce long RC delays in the path between sub-topologies. Multiple interfacing blocks (pipeline stages) can be added to meet timing requirements.

In the example 400, the peripheral NoC can comprise a first NoC sub-topology, interfacing block 1 can comprise an interfacing block, interfacing block 2 can comprise a second interfacing block, and the RISC-V NoC sub-topology can comprise a second sub-topology. In embodiments, the first NoC sub-topology and the second NoC sub-topology are based on different clock frequencies. In cases such as this, the interfacing block can enable a clock domain crossing. The clock domain crossing can be accomplished with an asynchronous FIFO, a synchronous FIFO, a two-flip-flop synchronizer, a toggle synchronizer, a pulse synchronizer, a gray encoder, a mux synchronizer, handshaking between clock domains, and so on. The clock crossing can also be accomplished with a digital phase locked loop (PLL) within the interfacing block. In embodiments, the interfacing block includes a digital phased lock loop (DPLL). Embodiments include sending, by the first NoC sub-topology, to the interfacing block, data and a first clock. In embodiments, the first NoC sub-topology is based on the first clock. In further embodiments, the first clock provides an input to the DPLL. Further embodiments include generating, by the DPLL, a second clock. The generating can be based on a reference clock, which can be the first clock from the first sub-topology that was sent. Further embodiments include forwarding, to the second NoC sub-topology, by the interfacing block, the second clock. In embodiments, the second NoC sub-topology is based on the second clock that was forwarded. In embodiments, the forwarding includes the data. The second clock can be the same as or different than the first clock. The second clock can be a multiple of the first clock, or any other frequency. The forwarding can include synchronizing the data that was saved with the second clock. Using this methodology, the interfacing block can enable a clock domain crossing. In embodiments, the interfacing block comprises a clock domain crossing block. Additional interfacing blocks, such as the additional interfacing block, can be added to accomplish additional clock boundary crossing or to synchronize data to be sent to other NoC sub-topologies.

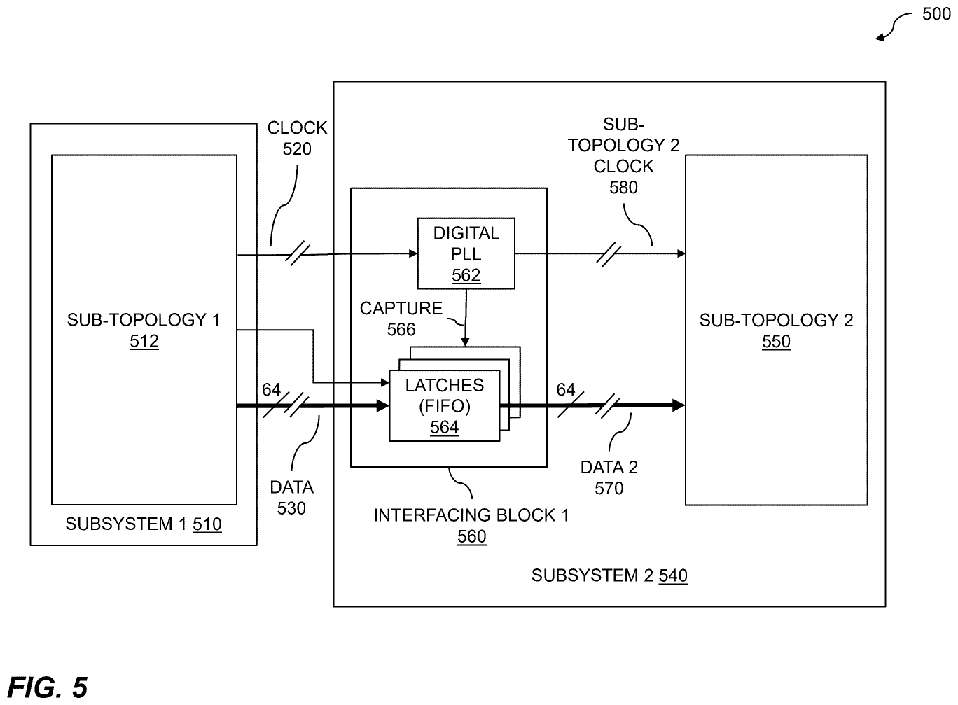

FIG. 5 is a detail of an interfacing block. An interfacing block can ease timing issues between sub-topologies within a NoC design. For example, limitations during floor planning may necessitate long wire path from a sending sub-topology to a receiving sub-topology. Long wire paths can introduce RC delays into signal propagation, thus preventing timing objectives from being met. The detail 500 depicts two subsystems within an SoC. The subsystems, or cores, in an SoC can include one or more central processing units (CPUs), memory, memory interfaces, graphic processing units (GPUs), third party logic, digital signal processors (DSPs), communications interfaces, analog and mixed signal subsystems, power management units, and more. The detail 500 includes a subsystem 1 510. A sub-topology 1 512 is included in subsystem 1 510. Sub-topology 1 can contain the network interface that couples the logic blocks in subsystem 1 to a NoC router in sub-topology 1. Sub-topology 1 can provide packetized communications to other sub-topologies within the SoC and can also contain clock and data signals that can be sent to another sub-topology in another subsystem.

The detail 500 includes a clock 520. Subsystems can include clock and timing generation logic to synchronize data transfers and other system events. The clock 520 can be used to synchronize a transfer of data via a data bus sent by sub-topology 1 to a receiving block such as interfacing block 1 560. A clock signal can indicate the instant of time when data on the data bus is valid and can be captured. A clock edge can be used to trigger a latch, flip-flop, etc. to capture data into a storage device. Data captures can be rising clock edge triggered, falling clock edge triggered, a combination of the two, or double data rate (DDR) which uses both rising and falling clock edges to capture data into a storage device. The detail 500 includes data 530. Data can be sent from sub-topology 1 to interfacing block 1. The sending data can be based on a NoC communications protocol. The NoC communications protocol can be coherent, non-coherent, or a mix of the two to accommodate the policies of the logic blocks within each subsystem. Communication between the sub-topology and the logic blocks in the subsystem 1 can include coherent communications protocols such as AMBA CHI, or non-coherent communications protocols such as AXI. Additional information can be sent by the logic block to a sub-topology 1 node. The information can include sending/receiving logic block ID, coherency data, priority data, or other data. The NoC communications protocol can include packets. The data bus width depicted in the detail 500 is 64-bits wide. Other bit-widths can be used. Control signals can be sent by sub-topology 1 along with the data for coordinated receiving by interfacing block 1.

The detail 500 includes a subsystem 2 540. Sub-topology 2 550 is shown within subsystem 2. Subsystem 2 can be located a long distance from subsystem 1 on the SoC. Finite latency and bandwidth limitations between subsystems can cause timing issues. For example, subsystem 1 can send data to subsystem 2. In order to accomplish this, a logic block within subsystem 2 can send the data to a node within sub-topology 1. The node can packetize the data to be sent, enabling the data to be sent over the NoC. The data can be sent, by a router, to sub-topology 2 within subsystem 2 where another node can depacketize the data and deliver it to the correct logic element. However, in a large SoC design, the distance between sub-topology 1 and sub-topology 2 can be too long to meet timing requirements. A number of methods can be used to alleviate this timing issue, such as widening data wiring channels and adding redrive buffers. Timing closure and performance limitations can also be resolved by the addition of interfacing block 1 that is part of the NoC structure. Interfacing block 1 can be inserted within sub-topology 2. Interfacing block 1 can also be inserted inside sub-topology 1 or outside of any sub-topology.

Interfacing block 1 can include a DPLL 562 and sufficient memory elements to temporarily save data before sending to a receiving block such as sub-topology 2. Saving, or buffering, can be performed on a first-in-first-out (FIFO) basis, where the first data in is the first data out. A FIFO buffer can be implemented with a hardware shift register, a series of latches, a register, a memory, and so on. Buffering involves the temporary storage of data. The FIFO buffer can be implemented with enough data depth to store expected data volumes without data overruns. The memory elements can be latches 564. The latches can be arranged in a FIFO configuration. A capture 566 signal can be supplied by the DPLL. The DPLL can be coupled to the incoming clock from the sending sub-topology 1. This incoming clock can be used by the DPLL as a reference clock to generate sub-topology 2 clock 580. The sub-topology 2 clock can be the same, a multiple, or otherwise different from the reference clock. The sub-topology 2 clock can be used as the internal clock for sub-topology 2.

The detail 500 includes data 2 570 traveling along a bus. The data 2 bus can send the data that was captured by the interfacing block to sub-topology 2. Data, via the data 2 bus can be received at sub-topology 2 in synchronization with the sub-topology 2 clock. The data 2 bus can be the same bit-width as the receiving sub-topology 2, as shown in the detail 500. However, the data 2 bus can be a different bit-width than the receiving sub-topology. In that case, the receiving can be based on a credit system. If buffers within sub-topology 2 are full, sub-topology 2 can remove credit from interfacing block 1. In response, interfacing block 1 can wait to send the next 64-bit data word until credit is restored (buffer space is available). A similar mechanism can be used for data exchanges between sub-topology 1 and interfacing block 1.

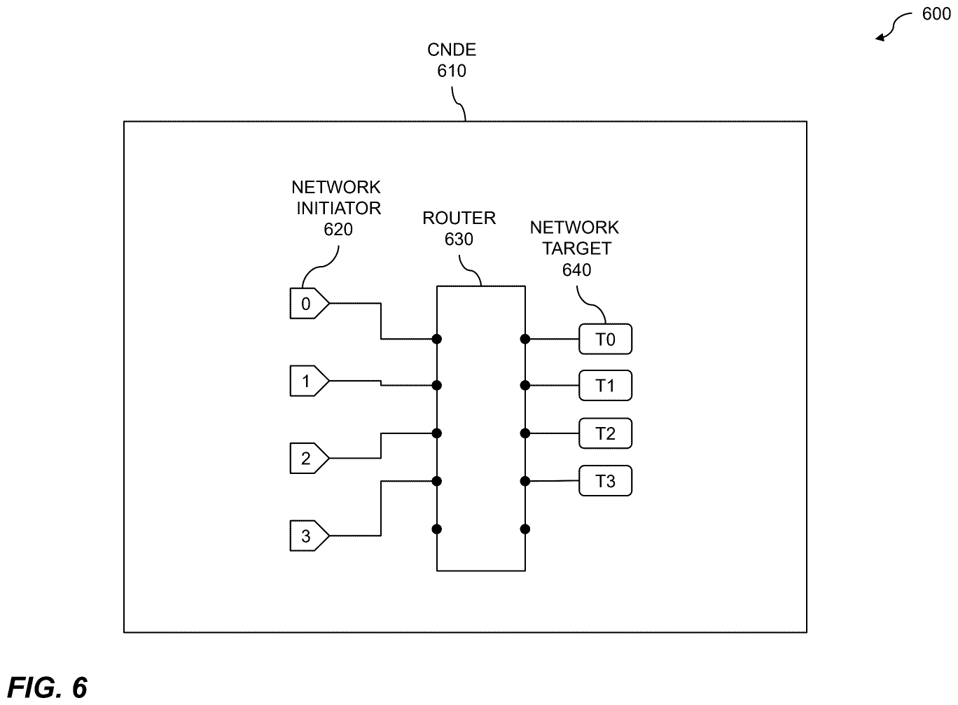

FIG. 6 is an example of a CNDE graphical interface. A CNDE can enable the design and representation of a NoC topology, such as a NoC topology included within an SoC design. The CNDE can be based on cloud-native software. The graphical design can be enabled within a database. The database can be collaborative. Embodiments include sharing, by the CNDE, the database, between two or more users. Thus, the CNDE can comprise a collaborative environment, enabling more than one user to view, edit, validate, etc. the NoC topology as it is designed. The graphical representation of the NoC topology within the CNDE, which can comprise a graphical user interface (GUI), can ease communication between designers who can be in remote locations, reducing the possibility of error. The CNDE can reveal errors, critical timing paths, performance issues, and so on. The CNDE can provide functionality for displaying the components of the NoC design, exploring a file system within the design environment, setting user sharing privileges, displaying performance matrices, validating topology and sub-topologies, generating register transfer language (RTL) of the topology, simulating the topology and/or sub-topologies, displaying of results, and so on.

The example 600 includes a CNDE 610. Embodiments include showing, by the CNDE, a graphical representation of the NoC topology. The example 600 illustrates a graphical representation within the CNDE of a simple NoC topology that can be viewed by a user, designer, verification engineer, and so on. The graphical representation can show one or more network initiators 620 within the NoC design. A network initiator can be a block of logic within a subsystem of the SoC, such as a processor core, that generates a data transaction. The network initiators can be within the same or one or more different subsystems within the SoC. The network initiators can be coupled to a router 630. The router can packetize data and/or direct packetized network traffic to other routers within the NoC topology (not shown in example 600). The example 600 can include one or more network targets 640. A network target can be a block of logic within a subsystem of the SoC, such as a memory device, that responds to a data transaction from a network initiator. The router can enable bidirectional communication between one or more network initiators and one or more network targets. One or more users can interact, via the CNDE, with the graphical representation of the NoC topology. This can include design, validation, checking, verification, netlist extraction, uploading or downloading data, and other processes or steps.

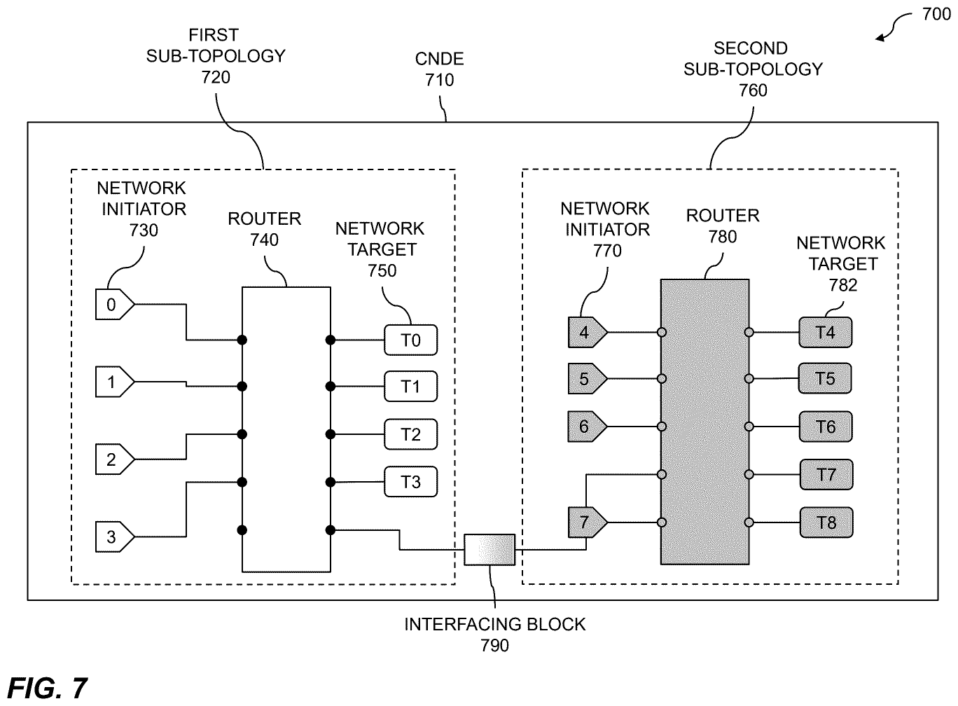

FIG. 7 is an example of NoC sub-topologies within a CNDE. As described above and throughout, a NoC topology can include a network that couples one or more subsystems within the SoC. Each of these subsystems can include a NoC sub-topology which can be part of the overall NoC topology. The NoC sub-topologies can contain network initiators, routers, network targets, and other elements. The sub-topologies can be coupled to other NoC sub-topologies via one or more routers. Each NoC sub-topology can include a packetized interface, can communicate over a coherent or a non-coherent protocol, can support transmissions over control protocol/internet protocol (TCP/IP), and so on. One or more interfacing blocks can be inserted between NoC sub-topologies. A first NoC sub-topology within the NoC topology can be created within the CNDE. A second NoC sub-topology within the NoC topology can be generated within the CNDE. An interfacing block can be inserted within the CNDE, enabling two-way communication between the first NoC sub-topology and the second NoC sub-topology. One or more additional interfacing blocks can be inserted. In embodiments, the creating, the generating, and the inserting occur graphically within the CNDE. Embodiments include showing, by the CNDE, a graphical representation of the NoC topology.

Multiple network sub-topologies can be created and represented within the CNDE shown at 710. The example 700 includes a first sub-topology 720. The first sub-topology includes one or more network initiators 730. A network initiator can be a block of logic within a subsystem of the SoC, such as a processor core, that generates a data transaction. The network initiators can be coupled to one or more routers 740. The routers can packetize data and/or direct packetized network traffic to other routers within the NoC topology. The first sub-topology can include one or more network targets 750. A network target can be a block of logic within a subsystem of the SoC, such as a memory device, that responds to a data transaction from a network initiator. The first sub-topology can be located within a first subsystem on an SoC design. The example 700 includes a second sub-topology 760. Similar to the first sub-topology, the second sub-topology can also include one or more network initiators 770 coupled to one or more routers 780. The routers can direct network traffic to one or more network targets 782. The first sub-topology can be located within the same subsystem as the second sub-topology within the SoC design or another subsystem. As shown in the example 700, the second NoC sub-topology can be presented by the CNDE in a different color than the first NoC sub-topology. Thus, embodiments include representing, by the CNDE, each NoC sub-topology within the NoC topology by a different color. The different color can be a shading, outline color, outline thickness, and so on. Displaying the sub-topologies in different colors can clarify NoC components to a user and can aid in the design process while helping to eliminate errors. Additional sub-topologies, network initiators, routers, and network targets can be added. It is possible for many other NoC topologies, including more or less sub-topologies, to be created, generated, inserted, simulated, validated, verified, etc. by the CNDE.

The example 700 includes an interfacing block 790. One or more interfacing blocks can be inserted between the first sub-topology and the second sub-topology. Interfacing blocks can complete a network path between sub-topologies. As shown in example 700, the interfacing block can be coupled to one or more routers within one or more sub-topologies. The interfacing block can also be shaded between two different colors to show that it is coupled between two different sub-topologies. In the example 700, the coupling can enable a network initiator from the first sub-topology to communicate with a network target within the second sub-topology. The interfacing block can enable communication between SoC subsystems when the first sub-topology and the second sub-topology are located in different SoC subsystems.

The interfacing blocks can also solve design differences between the SoC subsystems and/or NoC sub-topologies. For example, the first sub-topology can be based on a 128-bit data width, which can be a first data width, to accommodate a data width of a first SoC subsystem, while the second sub-topology can be based on a 64-bit data width, which can be a second data width, to accommodate the data width of a second NoC subsystem. The interfacing block can enable communication between the different data path widths. Embodiments include inserting data buffers within the interfacing block. In further embodiments, the first data width is different than the second data width. In this example, the interfacing block can implement a credit system. While data buffer space is available in the interfacing block, the first sub-topology sends 128-bit data, which can be captured by the interfacing block, which then can send the data in 64-bit segments to the second sub-topology. However, since the interfacing block is receiving twice as much data as it sends in a given timeframe, buffer storage within the interfacing block may become full at some point. When full or near full, the interfacing block can remove credit from the first sub-topology, causing the first sub-topology to pause sending data until the interfacing block can free space by sending 64-bit segments to the second sub-topology.

The clock frequency in the first sub-topology and the second sub-topology can be different frequencies or the same frequency. The clocks can be multiples of each other, asynchronous, and so on. In embodiments, the first NoC sub-topology and the second NoC sub-topology are based on different clock frequencies. In further embodiments, the interfacing block comprises a clock domain crossing block. A number of methods can be used when interfacing between sub-topologies with different clocks. For example, the interfacing block can include an asynchronous FIFO, a synchronous FIFO, a two-flip-flop synchronizer, a toggle synchronizer, a pulse synchronizer, a gray encoder, a mux synchronizer, handshaking between clock domains, and so on.

Furthermore, any sub-topology on an SoC can also be checked against any sub-topology on another chip. That is, multiple sub-topologies from multiple chips can communicate, which means they must be checked for appropriate interconnectivity. In some cases, a chip-to-chip bridge can be added to handle timing differences between the chips. Thus, multiple chiplets, such as processor chiplets, accelerator chiplets, transport crossbar chiplets, memory fabric chiplets, and so on, can be in a multilevel NoC topology across a complex system implementation.

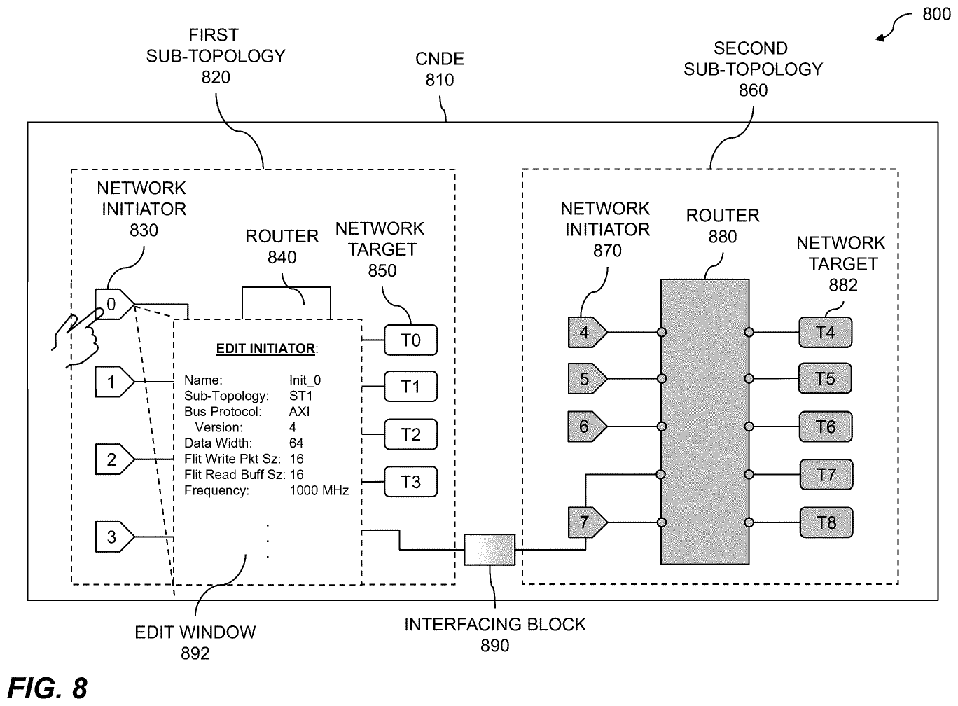

FIG. 8 is an example of editing a network initiator within a CNDE. The example 800 includes a CNDE 810. The CNDE can be based on cloud-native software. The CNDE can enable graphical design of a NoC topology within a database. As described previously, multiple network sub-topologies can be created and represented within the CNDE. The example 800 includes a first sub-topology 820. The first sub-topology includes one or more network initiators 830. A network initiator can be a block of logic within a subsystem of the SoC, such as a processor core, that generates a data transaction. The network initiators can be coupled to one or more routers 840. The routers can packetize data and/or direct packetized network traffic to other routers within the NoC topology. The first sub-topology can include one or more network targets 850. A network target can be a block of logic within a subsystem of the SoC, such as a memory device, that responds to a data transaction from a network initiator. The first sub-topology can be located within a first subsystem on a SoC design. The example 800 includes a second sub-topology 860. Similar to the first sub-topology, the second sub-topology can also include one or more network initiators 870 coupled to one or more routers 880. The routers can direct network traffic to one or more network targets 882. The first sub-topology can be located within the same subsystem as the second sub-topology within the SoC design or another subsystem. As shown in the example 800, the second NoC sub-topology can be presented by the CNDE in a different color than the first NoC sub-topology. Additional sub-topologies, network initiators, routers, and network targets can be added. It is possible that many other NoC topologies, including more or less sub-topologies, can be created, generated, inserted, simulated, validated, verified, etc. by the CNDE.

The example 800 includes an interfacing block 890. One or more interfacing blocks can be inserted between the first sub-topology and the second sub-topology. Interfacing blocks can complete a network path between sub-topologies. As shown in the example 800, the interfacing block can be coupled to one or more routers within one or more sub-topologies. The interfacing block can also be shaded between two different colors to show that it is coupled between two different sub-topologies. In the example 800, the coupling can enable a network initiator from the first sub-topology to communicate with a network target within the second sub-topology. The interfacing block can enable communication between SoC subsystems when the first sub-topology and the second sub-topology are located in different SoC subsystems.

The example 800 includes an edit window 892 within the CNDE. The CNDE can provide an interactive capability to edit characteristics of network initiators, routers, network targets, interfacing blocks, and so on. An edit mode can be initiated by a mouse-hover, a screen-touch, or other means of selection as shown in example 800. The CNDE can open a text box or other type of user interface (UI) feature that displays relevant parameters associated with the selected element. The example 800 shows a network initiator in the first sub-topology that has been selected for editing. Current design parameters can be displayed in the edit window. Some design parameters can be read-only while others can be editable. The editing can be accomplished by one or more users as part of the collaborative cloud-native software. The edit window can include a title which can identify the sub-topology element name and/or element type that is currently being edited. In the example 800, the name of the network initiator under editing is “Init_0.” This name can be assigned by default, by a designer, by imported design files, and so on.

Recall that a first NoC sub-topology within the NoC topology can be created within the CNDE. Recall also that a second NoC sub-topology within the NoC topology can be generated within the CNDE. Finally, recall that an interfacing block can be inserted within the CNDE, enabling two-way communication between the first NoC sub-topology and the second NoC sub-topology. In embodiments, the creating, the generating, and the inserting are based on importing data from a file. A file can be uploaded, by a user, to the CNDE. The file can contain design details of the NoC topology, including elements shown in example 800. The design details can include definitions, coupling data, metadata, parameters, floorplan information, timing details, etc. regarding each element or combination of elements within the NoC topology. Thus, embodiments include uploading, to the CNDE, floorplan information. Other embodiments include mapping, by the CNDE, the floorplan information to one or more logical entities within the NoC topology. Some or all of the information uploaded by the file can be viewed and edited by an edit window, such as shown at 892, for any element within the NoC topology. Other edit windows can include different information from that shown in the example 800. For example, the CNDE can map uploaded floorplan information regarding the selected network initiator and can show that information in the edit window. The CNDE can use the uploaded floorplan information for other purposes.

Embodiments include estimating power consumption of the NoC topology. When floorplan information, such as RC paths, driver information, and so on, has been uploaded, the CNDE can perform a power analysis to determine power consumption based on actual hardware data. Other embodiments include estimating latency information of the NoC topology. Uploaded floorplan information, especially placement and wire lengths, can be critical to determine timing between NoC topology elements. Latency can be estimated for paths within a NoC sub-topology, between NoC sub-topologies, and so on. The floorplan information can be used to determine if additional interfacing blocks should be added to the NoC topology. Embodiments include adding one or more additional interfacing blocks. In other embodiments, the floorplan information includes a wirelength above a third threshold. In further embodiments, the one or more additional interfacing blocks comprise one or more pipeline stages. The third threshold can be associated with a timing requirement.

The edit window can include a sub-topology field. The sub-topology field can define which sub-topology the design element is coupled to. In example 800, the selected network initiator is coupled within the “ST1” sub-topology. The edit window can include a bus protocol and bus version field. A sub-topology can be based on a coherent, non-coherent, etc. protocol. In example 800, the selected network initiator communicates over the AXI 4 protocol, which is a non-coherent protocol. Many other protocols are possible. The CNDE can validate that a sending sub-topology and a receiving sub-topology are based on the same protocol. An interfacing block can translate between protocols. The edit window can include a data width field. In example 800, the selected network initiator data width is 64 bits. Various sub-topologies can be based on different widths. Recall that the NoC topology can be validated. In embodiments, the validating includes comparing a first data width to a second data width. In further embodiments, the first data width is associated with the first NoC sub-topology. In embodiments, the second data width is associated with the second NoC sub-topology. The CNDE can validate that a sending sub-topology and a receiving sub-topology have the same data width. As described previously, communications between sub-topologies of different data widths can be accommodated by an interfacing block. The CNDE can validate that the interfacing block correctly bridges between two different data widths.

The edit window can include flit write packet and read buffer size fields. In the example 800, these fields are set to “16.” The sub-topologies can communicate using a packetized protocol. Each packet can comprise a number of flits, or flow control units. The flit can comprise header information which can define the routing path to the receiving node. Each sub-topology can include a different flit write and read buffer size. A credit system can be implemented to ensure that a flit is not sent when a receiving sub-topology does not have buffer space to receive it. The edit window can include a frequency field. In the example 800, the frequency of the selected network initiator is 1000 MHz Frequency can be set to other rates. The CNDE can validate that a sending sub-topology can send a packet to a receiving sub-topology that is frequency-matched. If the frequencies are different, disclosed embodiments can bridge frequency differences within the NoC topology.

The CNDE can provide additional details of any NoC element within an edit window. The CNDE can validate the details. In embodiments, the validating occurs in response to a change, in the CNDE, by a user. After the parameters are edited and saved, the simulation, validation, checking, and other steps may be repeated in the design sequence. This can occur automatically upon modification of a design parameter, or when the edit window is closed, by manual command of the designer, or by other means.

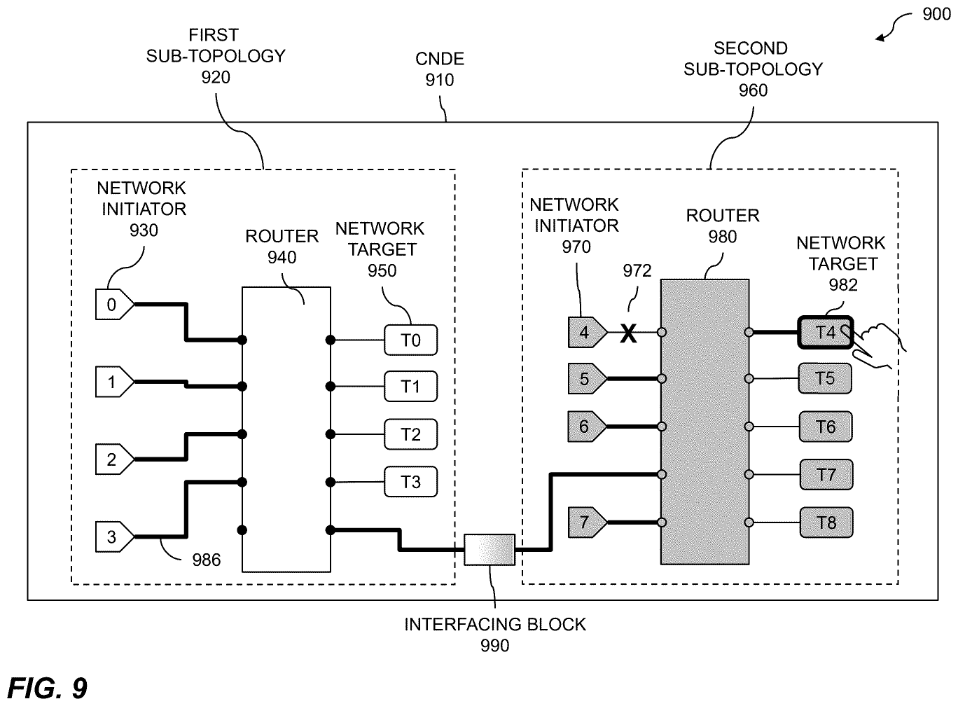

FIG. 9 is an example of tracing a connectivity error. The example 900 includes a CNDE 910. The CNDE can be based on cloud-native software. The CNDE can enable graphical design of a NoC topology within a database. Multiple network sub-topologies can be created and represented within the CNDE. The example 900 includes a first sub-topology 920. The first sub-topology includes one or more network initiators 930. The network initiators can be coupled to one or more routers 940. The first sub-topology can include one or more network targets 950. The first sub-topology can be located within a first subsystem on a SoC design. The example 900 includes a second sub-topology 960. Similar to the first sub-topology, the second sub-topology can also include one or more network initiators 970 coupled to one or more routers 980. The routers can direct network traffic to one or more network targets 982. The first sub-topology can be located within the same subsystem as the second sub-topology within the SoC design or another subsystem. As shown in the example 900, the second NoC sub-topology can be presented by the CNDE in a different color than the first NoC sub-topology. Additional sub-topologies, network initiators, routers, and network targets can be added. Many other NoC topologies, including more or less sub-topologies are possible to be created, generated, inserted, simulated, validated, verified, etc. by the CNDE. The example 900 includes an interfacing block 990. One or more interfacing blocks can be inserted between the first sub-topology and the second sub-topology. Interfacing blocks can complete a network path between sub-topologies. As shown in the example 900, the interfacing block can be coupled to one or more routers within one or more sub-topologies. The interfacing block can also be shaded between two different colors to show that it is coupled between two different sub-topologies. In the example 900, the coupling can enable a network initiator from the first sub-topology to communicate with a network target within the second sub-topology. The interfacing block can enable communication between SoC subsystems when the first sub-topology and the second sub-topology are located in different SoC subsystems.

The example 900 shows a connectivity error 972. The connectivity error can be identified by the CNDE. Recall that the NoC topology can be validated. The validating can ensure that the first network initiator is coupled to the first network target and the second network target, and that the second network initiator is coupled to the first network target and the second network target. In embodiments, the validating includes revealing, by the CNDE, one or more connectivity errors when one or more initiators are unable to communicate with one or more network targets. The example 900 shows that network initiator 4 is unable to communicate with network target 4 which was selected as shown. The inability to communicate can be due to a number of factors such as an error in coupling; a mismatch in frequency, data width, or protocol; and so on. The CNDE can detect errors such as these and report them to one or more users with access to the CNDE. Embodiments include highlighting a communications path to a network target when the network target is selected, by a user, within the CNDE. The CNDE can also reveal established communications paths from network initiators to network targets. The CNDE can highlight these paths graphically, allowing users to quickly identify whether the overall NoC topology will perform as expected. The example 900 shows that network target T4 was selected by a user. In response, the CNDE can reveal all network initiators that are correctly coupled to network target T4. This is shown in the example 900 by bold lines 986 extending to all network initiators except network initiator 4. Other means of highlighting can include a text box, a color, an alert, a sound, and so on.

Additional embodiments include extracting, by the CNDE, a NoC netlist. A NoC netlist can be a connectivity description of the overall NoC topology. The netlist can include elements within one or more sub-topologies. The netlist can be restricted to a portion of the overall NoC topology, as directed by the user. Recall that the CNDE can enable a graphical design of a NoC topology which can include a first network initiator, a first router, and first network target within a first NoC sub-topology such as shown at 920. Recall also that the NoC topology can include a second network initiator, a second router, and second network target within a second NoC sub-topology such as shown at 960. In embodiments, the NoC netlist includes one or more stubs. In further embodiments, the one or more stubs comprise an integration point for a description of the first network initiator, the second network initiator, the first network target, and the second network target. In other embodiments, the description is based on a hardware description language (HDL). The netlist can include stubs, or integration points, for additional elements of the NoC design such as additional network initiators and additional network targets. The router can also be included in the netlist from the CNDE, or a stub can be provided within the netlist.

The CNDE can perform additional calculations to aid the graphical design process. Embodiments include calculating, by the CNDE, one or more wirelengths. The wirelengths can be based on the netlist and/or floorplan information which can be uploaded to the CNDE. The wirelengths can be estimated. In embodiments, the one or more wirelengths are based on a Manhattan wiring algorithm. The CNDE can calculate wirelengths between network initiators and routers, between routers and network targets, between routers within the same sub-topology, between routers within different sub-topologies, between a router and an interfacing block, and so on. In this way, the user can obtain a full picture of potential timing issues due to long wirelengths within the entire NoC design. Embodiments include adding a second interfacing block. In further embodiments, the one or more wirelengths are above a first threshold. As the user reviews the calculated wirelengths, it may be determined that some paths will not meet design goals. This can be observed by comparing the calculated wirelengths to a first threshold. The first threshold can be a maximum length before the design must be changed to include additional buffering, wider wiring channels, a new pipeline stage, etc. This is most likely to occur between sub-topologies, but can also occur within a sub-topology. When considering a long wirelength between sub-topologies, one interfacing block, such as shown in the example 900, may not be sufficient to meet timing goals. A second interfacing block can be added to the NoC topology to ensure that timing goals can be met. In embodiments, the second interfacing block comprises a pipeline stage.

In some cases, the calculated wirelengths can show a group of network initiators and/or network targets that are far enough from other components to justify creating an additional NoC sub-topology. In embodiments, the calculating includes adding a third sub-topology. A determination as to whether to create another sub-topology can be based on a wirelength threshold. Thus, in embodiments, the one or more wirelengths are above a second threshold. In further embodiments, the third sub-topology is within the NoC topology.

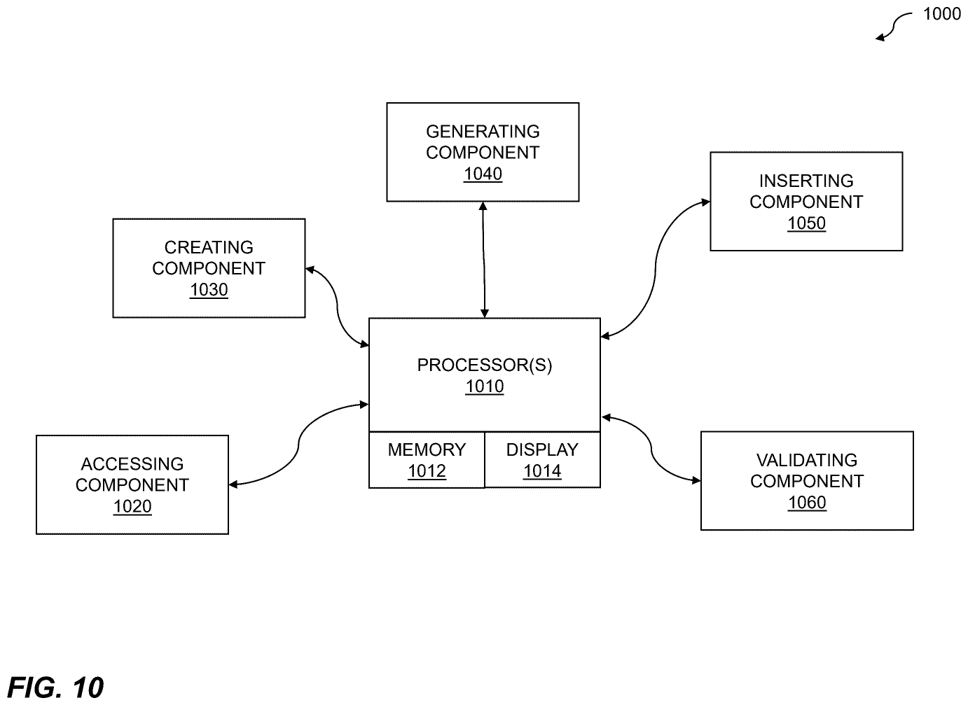

FIG. 10 is a system diagram for cloud-native network-on-chip validation with sub-topologies. Disclosed techniques enable collaborative NoC development based on a cloud-native graphical-based software. The system 1000 can include one or more processors 1010, which are coupled to a memory 1012 which stores instructions. The system 1000 can further include a display 1014 coupled to the one or more processors 1010 for displaying data, a graphical representation of a NoC topology, NoC sub-topologies, connectivity of NoC elements, and so on. In embodiments, one or more processors 1010 are coupled to the memory 1012, wherein the one or more processors, when executing the instructions which are stored, are configured to: access a collaborative Network-on-Chip (NoC) development environment (CNDE), wherein the CNDE is based on a cloud-native software, and wherein the CNDE enables graphical design of a NoC topology within a database; create, within the CNDE, a first NoC sub-topology, wherein the first NoC sub-topology is within the NoC topology, and wherein the creating includes coupling a first network initiator, a first router, and first network target; generate, within the CNDE, a second NoC sub-topology, wherein the second NoC sub-topology is within the NoC topology, and wherein the generating includes coupling a second network initiator, a second router, and second network target; insert, within the CNDE, an interfacing block, wherein the interfacing block enables two-way communication between the first NoC sub-topology and the second NoC sub-topology; and validate the NoC topology, wherein the validating ensures that the first network initiator is coupled to the first network target and the second network target, and that the second network initiator is coupled to the first network target and the second network target.

The system 1000 includes an accessing component 1020. The accessing component can include functions and instructions for accessing a collaborative Network-on-Chip (NoC) development environment (CNDE), wherein the CNDE is based on a cloud-native software, and wherein the CNDE enables graphical design of a NoC topology within a database. A collaborative development environment can enable two or more users to participate in the development of a SoC design. Cloud-native software can reside at a physically remote location, accessible as needed, using IT resources for delivery to the user. The interface to cloud-native software can be a web browser, a downloaded application, and so on. The CNDE can share the database between two or more users using an interface. Thus, more than one user is able to view, edit, validate, etc. the NoC topology as it is designed, updated, simulated, validated, and so on. The CNDE can provide functionality for displaying the components of the NoC design, exploring a file system within the design environment, setting user sharing privileges, displaying performance matrices, validating topology and sub-topologies, generating register transfer language (RTL) of the topology, simulating the topology and/or sub-topologies, displaying of results, and so on.

The system 1000 includes a creating component 1030. The creating component can include functions and instructions for creating, within the CNDE, a first NoC sub-topology, wherein the first NoC sub-topology is within the NoC topology, and wherein the creating includes coupling a first network initiator, a first router, and first network target. A NoC topology can include a network that couples one or more subsystems within the SoC. Each of the one or more subsystems can include a NoC sub-topology which can be part of the overall NoC design. A first NoC sub-topology can be created within the NoC topology. The first NoC sub-topology can be associated with any subsystem of the SoC, such as a processor, a peripheral component interconnect express (PCI-E) controller, security logic, and so on. The first NoC sub-topology can be coupled to other network sub-topologies via one or more routers. The first NoC sub-topology can include a packetized interface, can communicate over a coherent or a non-coherent protocol, can support transmissions over control protocol/internet protocol (TCP/IP), and so on. The first NoC sub-topology can include a first network initiator which can be a block of logic within a subsystem of the SoC, such as a processor core, that generates a data transaction. The first NoC sub-topology can include a first network target which can be a block of logic within a subsystem of the SoC, such as a memory device, that responds to a data transaction from a network initiator. The first NoC sub-topology can include a router. The first router can direct data transmissions, which can be in packetized form, from a network initiator to a network target. The first network initiator, the first router, and first network target can be coupled by the CNDE.

The system 1000 includes a generating component 1040. The generating component can include functions and instructions for generating, within the CNDE, a second NoC sub-topology, wherein the second NoC sub-topology is within the NoC topology, and wherein the generating includes coupling a second network initiator, a second router, and second network target. A user can use the CNDE to create more than one NoC sub-topology. A second NoC sub-topology can be associated with a subsystem of the SoC, such as a processor, PCI-E controller, security logic, and so on. The second NoC sub-topology can include one or more network initiators, one or more routers, one or more network targets, and so on. The initiators, routers, and targets within the second sub-topology can be coupled together, enabling packetized communication within the second sub-topology. The first sub-topology and the second sub-topology can be coupled within the CNDE to provide packetized communication between sub-topologies.

The system 1000 includes an inserting component 1050. The inserting component can include functions and instructions for inserting, within the CNDE, an interfacing block, wherein the interfacing block enables two-way communication between the first NoC sub-topology and the second NoC sub-topology. When two sub-topologies are too far apart to couple directly, an interfacing block can establish bidirectional communications between the sub-topologies. An interfacing block can comprise a pipeline stage to reduce long RC delays in the path between NoC sub-topologies. The interfacing blocks can include data buffers. Additionally, the interfacing block can be used when a sending sub-topology is sending data to a receiving sub-topology with a different width data bus. The inserting can include one or more interfacing blocks.

The system 1000 includes a validating component 1060. The validating component can include functions and instructions for validating the NoC topology, wherein the validating ensures that the first network initiator is coupled to the first network target and the second network target, and that the second network initiator is coupled to the first network target and the second network target. The NoC topology, which can include one or more sub-topologies and one or more interfacing blocks, can be validated. The validating can include checking that every communication path is coupled correctly and that the path will pass checks such as performance, timing, clock, protocol, etc. The validating can ensure that the first network initiator and the second network initiator can properly communicate with any desired network target, regardless of which sub-topology includes the initiators and targets. The validating can include criteria such as performance, timing, clock, bus width, protocol, and so on.

The system 1000 can include a computer program product embodied in a non-transitory computer readable medium for design automation, the computer program product comprising code which causes one or more processors to perform operations of: accessing a collaborative Network-on-Chip (NoC) development environment (CNDE), wherein the CNDE is based on a cloud-native software, and wherein the CNDE enables graphical design of a NoC topology within a database; creating, within the CNDE, a first NoC sub-topology, wherein the first NoC sub-topology is within the NoC topology, and wherein the creating includes coupling a first network initiator, a first router, and first network target; generating, within the CNDE, a second NoC sub-topology, wherein the second NoC sub-topology is within the NoC topology, and wherein the generating includes coupling a second network initiator, a second router, and second network target; inserting, within the CNDE, an interfacing block, wherein the interfacing block enables two-way communication between the first NoC sub-topology and the second NoC sub-topology; and validating the NoC topology, wherein the validating ensures that the first network initiator is coupled to the first network target and the second network target, and that the second network initiator is coupled to the first network target and the second network target.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the abovementioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A processor-implemented method for design automation comprising:
accessing a collaborative Network-on-Chip (NoC) development environment (CNDE), wherein the CNDE is based on a cloud-native software, and wherein the CNDE enables graphical design of a NoC topology within a database;
creating, within the CNDE, a first NoC sub-topology, wherein the first NoC sub-topology is within the NoC topology, and wherein the creating includes coupling a first network initiator, a first router, and first network target;
generating, within the CNDE, a second NoC sub-topology, wherein the second NoC sub-topology is within the NoC topology, and wherein the generating includes coupling a second network initiator, a second router, and second network target;
inserting, within the CNDE, an interfacing block, wherein the interfacing block enables two-way communication between the first NoC sub-topology and the second NoC sub-topology; and
validating the NoC topology, wherein the validating ensures that the first network initiator is coupled to the first network target and the second network target, and that the second network initiator is coupled to the first network target and the second network target.

2. The method of claim 1 wherein the first NoC sub-topology and the second NoC sub-topology are based on different clock frequencies.

3. The method of claim 2 wherein the interfacing block includes a digital phased lock loop (DPLL).

4. The method of claim 3 further comprising sending, by the first NoC sub-topology, to the interfacing block, data and a first clock, wherein the first NoC sub-topology is based on the first clock, and wherein the first clock provides an input to the DPLL.

5. The method of claim 4 further comprising generating, by the DPLL, a second clock.

6. The method of claim 5 further comprising forwarding, to the second NoC sub-topology, by the interfacing block, the second clock, wherein the second NoC sub-topology is based on the second clock that was forwarded, and wherein the forwarding includes the data.

7. The method of claim 2 wherein the interfacing block comprises a clock domain crossing block.

8. The method of claim 1 wherein the validating includes comparing a first data width to a second data width, wherein the first data width is associated with the first NoC sub-topology, and wherein the second data width is associated with the second NoC sub-topology.

9. The method of claim 8 further comprising inserting data buffers, within the interfacing block, wherein the first data width is different than the second data width.

10. The method of claim 1 further comprising extracting, by the CNDE, an NoC netlist.

11. The method of claim 10 wherein the NoC netlist includes one or more stubs, wherein the one or more stubs comprise an integration point for a description of the first network initiator, the second network initiator, the first network target, and the second network target, and wherein the description is based on a hardware description language (HDL).

12. The method of claim 11 further comprising calculating, by the CNDE, one or more wirelengths.

13. The method of claim 12 wherein the calculating includes adding a second interfacing block, wherein the one or more wirelengths are above a first threshold, wherein the second interfacing block comprises a pipeline stage.

14. The method of claim 12 wherein the calculating includes adding a third sub-topology, wherein the one or more wirelengths are above a second threshold, wherein the third sub-topology is within the NoC topology.

15. The method of claim 10 further comprising uploading, to the CNDE, floorplan information.

16. The method of claim 15 further comprising mapping, by the CNDE, the floorplan information to one or more logical entities within the NoC topology.

17. The method of claim 16 further comprising adding one or more additional interfacing blocks, wherein the floorplan information includes a wirelength above a third threshold, wherein the one or more additional interfacing blocks comprise one or more pipeline stages.

18. The method of claim 15 further comprising estimating power consumption of the NoC topology.

19. The method of claim 15 further comprising estimating latency information of the NoC topology.

20. The method of claim 1 further comprising sharing, by the CNDE, the database, between two or more users.

21. A computer program product embodied in a non-transitory computer readable medium for design automation, the computer program product comprising code which causes one or more processors to generate semiconductor logic for:
accessing a collaborative Network-on-Chip (NoC) development environment (CNDE), wherein the CNDE is based on a cloud-native software, and wherein the CNDE enables graphical design of a NoC topology within a database;
creating, within the CNDE, a first NoC sub-topology, wherein the first NoC sub-topology is within the NoC topology, and wherein the creating includes coupling a first network initiator, a first router, and first network target;
generating, within the CNDE, a second NoC sub-topology, wherein the second NoC sub-topology is within the NoC topology, and wherein the generating includes coupling a second network initiator, a second router, and second network target;
inserting, within the CNDE, an interfacing block, wherein the interfacing block enables two-way communication between the first NoC sub-topology and the second NoC sub-topology; and
validating the NoC topology, wherein the validating ensures that the first network initiator is coupled to the first network target and the second network target, and that the second network initiator is coupled to the first network target and the second network target.

22. A computer system for design automation comprising:
a memory which stores instructions;
one or more processors coupled to the memory wherein the one or more processors, when executing the instructions which are stored, are configured to:
access a collaborative Network-on-Chip (NoC) development environment (CNDE), wherein the CNDE is based on a cloud-native software, and wherein the CNDE enables graphical design of a NoC topology within a database;
create, within the CNDE, a first NoC sub-topology, wherein the first NoC sub-topology is within the NoC topology, and wherein creating includes coupling a first network initiator, a first router, and first network target;
generate, within the CNDE, a second NoC sub-topology, wherein the second NoC sub-topology is within the NoC topology, and wherein generating includes coupling a second network initiator, a second router, and second network target;
insert, within the CNDE, an interfacing block, wherein the interfacing block enables two-way communication between the first NoC sub-topology and the second NoC sub-topology; and
validate the NoC topology, wherein validating ensures that the first network initiator is coupled to the first network target and the second network target, and that the second network initiator is coupled to the first network target and the second network target.
